(19) United States
(12) Patent Application Publication
(10) Pub. No.: US 2025/0092963 A1
(43) Pub. Date: Mar. 20, 2025

(54) FLOW RESTRICTOR FOR A MASS FLOW CONTROLLER

(71) Applicant: Festo SE & Co. KG, Esslingen (DE)

(72) Inventors: Michael WIELAND, Murrhardt (DE); Martin KILB, Leinfelden-Echterdingen (DE); Sebastian MÜLLER, Walddorfhäslach (DE); Jörg SIEBERT, Esslingen (DE)

(21) Appl. No.: 18/830,271

(22) Filed: Sep. 10, 2024

(30) Foreign Application Priority Data
Sep. 15, 2023 (DE) 10 2023 125 077.9

(51) Int. Cl. F16K 47/04

(52) U.S. Cl. CPC F16K 47/04

(57) ABSTRACT

Flow restrictor for a mass flow controller, having at least two flow guiding elements from the group: inlet plate with at least one inlet bore, throttle plate with at least one throttle bore, outlet plate with at least one outlet bore. The flow guiding elements are arranged at a distance from one another and wherein the at least one inlet bore, the at least one throttle bore and the at least one outlet bore are each arranged offset from one another in a spatial direction transverse to a central axis of the flow restrictor.

This application claims the benefit of German application DE 10 2023 125 077.9 filed Sep. 15, 2023, which is incorporated herein by reference.

The invention relates to a flow restrictor for a mass flow controller, which mass flow controller is designed to control a fluid mass flow.

U.S. Pat. No. 8,910,656 discloses a fluid regulator with a carrier unit, a fluid control valve, pressure sensors and a housing, wherein a fluid channel is formed in the housing, which is provided with a flow restrictor formed as a laminar flow element for determining a fluid mass flow, which flow restrictor has a defined flow resistance dependent on the fluid mass flow. The pressure difference caused by the flow restrictor is determined by the pressure sensors and enables the fluid mass flow through the fluid channel to be calculated.

### SUMMARY OF THE INVENTION

The task of the invention is to provide a flow restrictor for a mass flow controller designed to control a fluid mass flow, which has a compact design.

This task is solved for a flow restrictor with the following features: the flow restrictor has at least two flow guiding elements from the group: inlet plate with at least one inlet bore, throttle plate with at least one throttle bore, outlet plate with at least one outlet bore, wherein the flow guiding elements are arranged at a distance from one another and wherein the at least one inlet bore, the at least one throttle bore and the at least one outlet bore are each arranged offset from one another in a spatial direction transverse to a central axis of the flow restrictor.

If the flow restrictor comprises an inlet plate and a throttle plate, the bores of the inlet plate and the throttle plate are arranged offset from one another in the spatial direction. If the flow restrictor comprises an inlet plate and an outlet plate, the bores of the inlet plate and the outlet plate are arranged offset from one another in the spatial direction. If the flow restrictor comprises a throttle plate and an outlet plate, the bores of the throttle plate and the outlet plate are arranged offset from one another in the spatial direction. If the flow restrictor comprises an inlet plate, a throttle plate and an outlet plate, the bores of the inlet plate, the throttle plate and the outlet plate are arranged offset from one another in the spatial direction. Such a flow restrictor can also be referred to as a turbulence restrictor, since the flow guiding elements cause a multiple flow deflection for a fluid flow and these flow deflections cause a turbulent fluid flow.

The use of the turbulence throttle makes it possible to generate a significant pressure difference, which enables precise differential pressure measurement, while maintaining a small installation space requirement. This applies in particular when comparing the installation space requirement of the turbulence throttle with the installation space requirement of a laminar flow element.

The function of the turbulence throttle is based on the fact that the fluid flow is deflected several times, in particular at least twice, when passing through the turbulence throttle and thus undergoes a multiple change in flow direction, whereby the desired significant pressure drop across the turbulence throttle can be achieved.

For this purpose, at least two, preferably three, flow guiding elements are arranged in the turbulence restrictor, each of which has one or more bores. The bores of adjacent flow guiding elements are arranged and designed in such a way that there are no overlaps between the projections of the bores of the adjacent flow guiding elements in a projection plane that is aligned transverse to a main flow direction of the fluid mass flow, in particular transverse to a central axis of the turbulence restrictor.

Depending on the design of the flow guiding elements and depending on a fluid pressure provided at the supply connection, the fluid flow flows through the bores of the flow guiding elements at a speed below the speed of sound or at a speed above the speed of sound. A turbulence restrictor that is operated in the subcritical flow mode requires slightly more installation space. In contrast, a turbulence restrictor that is operated in the supercritical flow mode can be built more compactly. Depending on the intended use for the mass flow controller in which the turbulence restrictor is to be integrated, the turbulence restrictor should be designed so that either a subcritical flow mode or a supercritical flow mode is present over the entire intended mass flow control range.

As an example, such a flow restrictor can be arranged in a working channel of a mass flow controller. In this working channel, the flow restrictor causes a pressure drop that is dependent on the fluid mass flow and is caused by the turbulence in the fluid flow, whereby the fluid flow runs between an inlet connection of the working channel and a working connection of the working channel. By measuring the differential pressure caused by the pressure drop, it is possible to draw conclusions about the fluid mass flow passing through the working channel using a suitable calculation model. Alternatively, a differential pressure signal generated directly by the pressure sensor arrangement can be provided to a controller, in particular a microcontroller, in which the calculation of the fluid mass flow is carried out, or several discrete pressure signals can be provided to the controller for further processing.

For example, the task of the controller can be to determine a differential pressure from the sensor signals of the pressure sensor arrangement as well as an absolute pressure and a temperature and, using a mathematical model, to draw a conclusion from this differential pressure about the respective fluid mass flow in the working channel in which the turbulence restrictor is arranged. The controller then compares the determined fluid mass flow rate with a specified or predetermined fluid mass flow rate. Any difference between the determined fluid mass flow and the predetermined fluid mass flow is used to generate one or more control signals for a valve module, which can be used to influence the fluid flow in the working channel in order to minimize the determined difference.

Preferably, the control signals provided by the controller are implemented in the valve module in such a way that the throttling effect of the valve module is adapted to the required fluid mass flow, thereby ensuring a closed loop control for the fluid mass flow output by the mass flow controller at the working port.

The combination of the valve module, the controller and the working channel equipped with the turbulence restrictor can be referred to as a mass flow controller. Alternatively, a mass flow sensor designed to determine a fluid mass flow can be realized with the turbulence restrictor without the valve module.

Preferably the design of the turbulence restrictor is such that it always has the same throttling properties regardless of the direction of flow, so that a fluid source that can provide a vacuum can also be connected to the supply connection of the mass flow controller as an alternative to a fluid source that can provide a pressurized fluid and the mass flow controller is ab to control the fluid flow correct independent from the direction of flow. However, it may be necessary to adapt the valve module depending on the fluid source.

Advantageous further embodiments of the invention are the subject of the subclaims.

It is preferably provided that the at least one inlet bore, the at least one throttle bore and the at least one outlet bore are arranged offset to one another without overlapping in a projection plane aligned transversely to the central axis. This ensures that each gas molecule in the fluid flow inevitably undergoes the multiple deflection of the flow direction required to ensure high measuring accuracy for the differential pressure measurement. Due to the offset arrangement between the at least one inlet bore and the at least one throttle bore and/or between the at least one throttle bore and the at least one outlet bore, none of the gas molecules can pass through the turbulence restrictor on a flow path aligned parallel to the center axis of the working channel.

It is advantageous if the inlet plate has a plurality of inlet bores which are radially spaced from the center axis and/or that the throttle bore of the throttle plate is aligned coaxially with the center axis and/or that the outlet plate has a plurality of outlet bores which are radially spaced from the center axis.

In a further development of the invention, it is provided that a total cross-section of the inlet bores is equal to or greater than a cross-section of the throttle bore and/or that the cross-section of the throttle bore is equal to or greater than the total cross-section of the outlet bores. The total cross-section is defined as the cross-section that results from the addition of all the cross-sections of the inlet bores or the outlet bores and which is related to the cross-section of the, preferably single, throttle bore. If the total cross-section of the inlet bores and/or the outlet bores is equal to the cross-section of the throttle bore, it can be assumed that the throttling effect of the turbulence restrictor is independent of the direction of flow, provided that the inlet plate is at the same distance from the throttle plate as the outlet plate is spaced from the throttle plate. If such flow direction independence is not required, it can be provided that the total cross-section of the inlet bores is larger than the cross-section of the throttle bore. In addition or alternatively, the total cross-section of the outlet bores can be smaller than the cross-section of the throttle bore. This increases the throttling effect of the turbulence restrictor and thus increases the pressure difference at the same fluid flow compared to the flow direction of the independent turbulence restrictor.

In a further embodiment of the invention, it is provided that the throttle plate is designed as a circular disk through which the throttle bore passes, starting from a front circular surface to a rear circular surface, and that a front annular collar extends from the front circular surface in the axial direction, which annular collar is designed for a flat contact with the inlet plate, and/or that a rear annular collar extends from the rear circular surface in the axial direction, which is designed for a flat contact with the outlet plate. Thus, in addition to its throttling function, which is determined by the throttle bore and its arrangement relative to the inlet bores of the inlet plate and/or to the outlet bores of the outlet plate, the throttle plate has a further function, which is to ensure a predetermined distance between the inlet plate and/or the outlet plate. For this purpose, the throttle plate has a circular disk-shaped base body, which can also be described as a circular cylinder section with a centrally arranged throttle bore. Starting from a front circular surface of this base body, a front annular collar can be extended in the axial direction, which is designed with an end face facing away from the base body for contact with the inlet plate. Starting from a rear circular surface of this base body, a rear annular collar can extend in the axial direction, which is formed with an end face that repels the base body for contact with the outlet plate. Preferably, an inner diameter of the front annular collar and/or an inner diameter of the rear annular collar is selected in such a way that there is no need to fear any impairment of the fluid flow between the inlet plate and the throttle plate or between the throttle plate and the outlet plate.

It is useful if all inlet bores are formed with the same bore diameter at the same angular pitch and with the same radial distance to the center axis on the inlet plate and/or that all outlet bores are formed with the same bore diameter at the same angular pitch and with the same radial distance to the center axis on the outlet plate. This ensures a symmetrical distribution of the fluid flow provided at the supply connection through the inlet plate and/or the outlet plate in relation to the central axis of the working channel, which results in an advantageous flow behavior for the fluid flow in the turbulence restrictor. Compared to an asymmetrical distribution of the fluid flow provided at the supply connection, this results in a more stable curve for the pressure difference measurement.

It is preferable that an axial extension of the throttle bore along the central axis corresponds to 2 to 10 times the axial extension of the inlet bore and/or 2 to 10 times the axial extension of the outlet bore.

It is advantageous if the turbulence restrictor comprises the inlet plate, the throttle plate and the outlet plate and that the inlet plate, the throttle plate and the outlet plate are arranged in a throttle sleeve which has an external diameter that corresponds to an internal diameter of the working channel. This forms an independent assembly that can be manufactured, mounted and tested independently.

### BRIEF DESCRIPTION OF DRAWINGS

An advantageous embodiment of the invention is shown in the drawing. It shows:

FIG. 1 a schematic sectional view of a flow restrictor designed as a turbulence restrictor with an inlet plate, a throttle plate and an outlet plate,

FIG. 2 a top view of the inlet plate as shown in FIG. 1, and

FIG. 3 a top view of the throttle plate as shown in FIG. 1

### DETAILED DESCRIPTION OF INVENTION

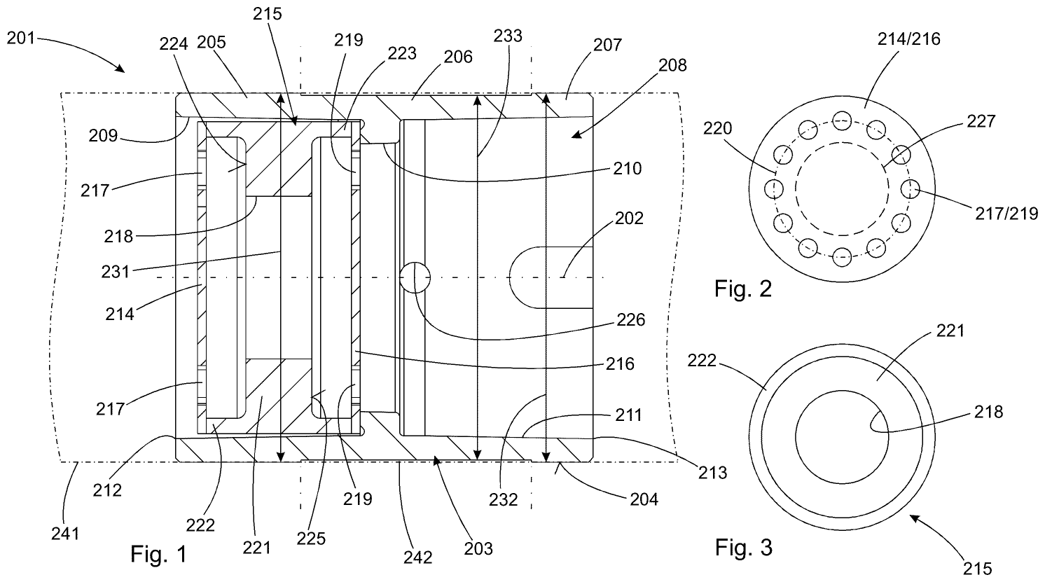

A flow restrictor shown in FIG. 1, referred to as turbulence restrictor 201, is designed as an independent assembly that can be mounted independently and tested with regard to its functionality. The turbulence restrictor 201 comprises a tubular throttle sleeve 203, which is rotationally symmetrical to a central axis 202 and extends along the central axis 202.

An outer surface 204 of the throttle sleeve 203 is divided purely by way of example into three sections adjoining one another along the central axis 202, namely a first guide section 205, a fluid section 206 and a second guide section 207. Here, the first guide section 205 has a first outer diameter 231 and the second guide section 207 has a second outer diameter 232, which are preferably identical. The fluid section 206 arranged between the first guide section 205 and the second guide section 207 has a third outer diameter 233, which is smaller than the outer diameters 231 and 232 of the two guide sections 205, 207.

When the turbulence restrictor 201 is mounted in a working channel 241 of a mass flow controller (not shown in detail), which working channel 241 is only shown schematically and is designed as a circular cylindrical bore, the fluid section 206 forms an annular channel 242 with the working channel 241, at which, for example, a fluid pressure present downstream of the turbulence restrictor 201 in the working channel 241 can be determined by means of a pressure sensor (not shown).

A purely exemplary bore 208 of the throttle sleeve 203, which is rotationally symmetrical to the central axis 202, can be subdivided into an inflow section 209, a retaining section 210 and an outflow section 211. The inflow section 209 and the outflow section 211 have a larger diameter than the holding section 210. Purely by way of example, it is envisaged that both the inflow section 209 and the outflow section 211 are each slightly widened in a conical shape starting from the holding section 210 up to an inflow opening 212 or up to an outflow opening 213. As an example, a flow through the turbulence restrictor 201 is provided with a fluid flow flowing from left to right as shown in FIG. 1, although a flow in the opposite direction can also be provided.

A plurality of flow guiding elements 214, 215, 216 are arranged in the inflow section 209, with which the desired turbulence throttling function can be produced when a gaseous fluid flows through the turbulence restrictor 201. Starting from the inflow opening 212, an inlet plate 214, a throttle plate 215 directly adjacent thereto in the axial direction along the central axis 202 and an outlet plate 216 directly adjacent to the throttle plate 215 in the axial direction along the central axis 202 are provided in the inflow section 209.

As can be seen from the representations of FIGS. 1 and 2, the inlet plate 214 is circular disk-shaped and designed as a plane-parallel plate and has a plurality of inlet bores 217, which are arranged purely by way of example on a common pitch circle 220 at a constant angular pitch relative to one another. By way of example, the inlet plate 214 can be made from a metal sheet which is provided with the inlet holes 217 by a laser cutting process or an etching process. Alternatively, the inlet plate can also be made of a plastic material, in particular in a plastic injection molding process.

It is preferable that the inlet plate 214 and the outlet plate 216 are of identical design.

Compared to the inlet plate 214 and the outlet plate 216, the throttle plate 215 has a considerably larger axial extension along the central axis 202. The throttle plate 215 can be subdivided into a throttle disk 221 and an upstream spacer ring 222 and a downstream spacer ring 223. The throttle disk 221 is circular in shape and has an outer diameter that is slightly smaller than an inner diameter of the inflow section 209. The throttle disk 221 is provided with exactly one throttle bore 218, which is arranged coaxially to the outer diameter of the throttle disk 221. By way of example only, the throttle bore 218 is circular.

As can be seen from the illustration in FIG. 1, the throttle disk 221 has an axial extension along the central axis 202 which corresponds to approximately 7 times an axial extension of the inlet plate 214 or the outlet plate 216. Circular spacer rings 222, 223, which serve as axial spacers for the inlet plate 214 and the outlet plate 216, respectively, project from the throttle disk 221 on opposite axial end faces 224, 225. The spacer rings 222, 223 each have an inner diameter, which is selected such that the inlet bores 217 of the inlet plate 214 and the outlet bores 219 of the outlet plate 216 are not covered. Rather, the spacer rings 222, 223 are provided exclusively for the spaced arrangement of the inlet plate 214 and the outlet plate 216 and practically do not participate in the throttling effect of the turbulence restrictor 201, which is described in more detail below.

The task of the retaining section 210, which has a slightly smaller internal diameter than the subassembly comprising inlet plate 214, throttle plate 215 and outlet plate 216, is exclusively to provide axial support for this subassembly and also practically does not participate in the throttling effect of the turbulence restrictor 201, which is described in more detail below.

The outflow section 211 has an essentially identical axial extension along the central axis as the inflow section 209 and serves to calm the fluid flow after it has passed through the flow guiding elements described above.

Furthermore, a radial bore 226 is formed in the outflow section 211, which ensures fluidic communication between the outflow section 211 and the annular channel which is located between the fluid section 206 and the working channel 241. The radial bore 206 enables a fluid pressure prevailing in the outflow section 211 to be tapped for the purpose of differential pressure measurement.

As can be seen from the representation of FIG. 2, a projection 227 of the throttle bore 218 onto the inlet plate 214 has no overlaps with the inlet bores 217. This ensures that a fluid, in particular a compressed air flow or a process gas flow, which flows through the turbulence restrictor 201, experiences a multiple deflection of its flow direction. This causes the desired turbulent flow in the turbulence restrictor 201.

The advantage of such a turbulent flow is that the compactly designed turbulence restrictor 201 enables a differential pressure measurement in which a pressure value upstream or upstream of the turbulence restrictor 201, in particular in the region of the inlet opening 212, can be significantly differentiated from a pressure value downstream or downstream of the turbulence restrictor 201, in particular at the radial bore 226, thereby enabling a precise differential pressure measurement. This differential pressure measurement can then be used to infer the fluid mass flow through the turbulence restrictor 201 with a high degree of accuracy.

1. A flow restrictor for a mass flow controller, having at least two flow guiding elements from the group: inlet plate with at least one inlet bore, throttle plate with at least one throttle bore, outlet plate with at least one outlet bore, wherein the flow guiding elements are arranged at a distance from one another and wherein the at least one inlet bore and/or the at least one throttle bore and/or the at least one outlet bore are each arranged offset from one another in a spatial direction transverse to a center axis of the flow restrictor.

2. The flow restrictor according to claim 1, wherein the at least one inlet bore and/or the at least one throttle bore and/or the at least one outlet bore are arranged offset with respect to one another without an overlap in a projection plane aligned transversely to the center axis.

3. The flow restrictor according to claim 1, wherein the inlet plate has a plurality of inlet bores which are radially spaced from the central axis and/or wherein the throttle bore of the throttle plate is aligned coaxially with the central axis and/or wherein the outlet plate has a plurality of outlet bores which are radially spaced from the central axis.

4. The flow restrictor according to claim 3, wherein a total cross-section of the inlet bores is equal to or greater than a cross-section of the throttle bore and/or wherein the cross-section of the throttle bore is equal to or greater than a total cross-section of the outlet bores.

5. The flow restrictor according to claim 1, wherein the throttle plate is designed as a circular disc through which the throttle bore passes, starting from a front circular surface to a rear circular surface, and wherein, starting from the front circular surface, a front annular collar extends in the axial direction, which is designed for a planar contact with the inlet plate, and/or starting from the rear circular surface, a rear annular collar extends in the axial direction, which is designed for a planar contact with the outlet plate.

6. The flow restrictor according to claim 3, wherein all inlet bores are formed on the inlet plate with the same bore diameter at the same angular pitch and with the same radial distance from the center axis and/or wherein all outlet bores are formed on the outlet plate with the same bore diameter at the same angular pitch and with the same radial distance from the center axis.

7. The flow restrictor according to claim 1, wherein an axial extent of the throttle bore along the center axis corresponds to 2 times to 10 times of an axial extent of the inlet bore and/or 2 times to 10 times of an axial extent of the outlet bore.

8. The flow restrictor according to claim 1, wherein the inlet plate and/or the throttle plate and/or the outlet plate are arranged in a throttle sleeve extending along the central axis.
